(19) United States
(12) Patent Application Publication
(10) Pub. No.: US 2006/0124864 A1
(43) Pub. Date: Jun. 15, 2006

(54) Air bearing compatible with operation in a vacuum

(75) Inventor: Michael Reid Sogard, Menlo Park, CA (US)

Correspondence Address: AKA CHAN LLP, 900 LAFAYETTE STREET, SUITE 710, SANTA CLARA, CA, 95050, US

(73) Assignee: Nikon Corporation, Tokyo (JP)

(21) Appl. No.: 11/011,863

(22) Filed: Dec. 14, 2004

(51) Int. Cl. G01N 23/00

(52) U.S. Cl. 250/491.1

(57) ABSTRACT

Methods and apparatus for enabling the stroke length of a linear guide that is suitable for use in an environment with high vacuum levels to be substantially independent of a length associated with the linear guide are disclosed. According to one aspect of the present invention, a guide bearing system includes a linear guide and a first guide beam. The linear guide has an inner surface which includes an air pad. The linear guide is wrapped around the first guide beam such that it may slide with respect to the guide beam. The guide beam includes a first chamber that is in fluid communication with the linear guide through at least one of a first plurality of ports in the guide beam which enable access to the first chamber.

### BACKGROUND OF THE INVENTION

1. Field of Invention

The present invention relates generally to semiconductor processing equipment. More particularly, the present invention relates to a stage for use in a lithography system requiring a controlled environment, such as a vacuum. Such systems include an electron beam projection lithography system and an extreme ultraviolet (EUV) lithography system.

2. Description of the Related Art

Lithography processes are integral to the fabrication of wafers and, hence, semiconductor chips. Future systems used for lithography are expected to include electron beam projection systems which project electron beams of finite area through a patterned reticle, as well as extreme ultraviolet (EUV) lithography systems. The reticle effectively serves as a template for a corresponding pattern on a wafer. For an electron beam projection system, a relatively broad beam of electrons may be collimated and provided to a reticle, which may be fabricated from a silicon wafer, e.g., a wafer that has been etched to make a thin patterned membrane, which is suitable for scattering with angular limitation projection electron beam lithography. Typically, rather than absorbing the beam, the pattern scatters portions of the beam in order to prevent electrons from being ultimately focused onto a wafer.

Although separate vacuum chambers may be used to house a reticle and a wafer for use with a lens system of an electron beam projection system, the lens system is often housed in a single vacuum chamber. FIG. 1 is a diagrammatic representation of an electron beam projection system which is contained within a vacuum chamber. A lens system 4 housed within a vacuum chamber 9 includes an illumination lens 5 and a projection lens 7. An electron beam is arranged to pass through illumination lens 5. The electron beam then passes from illumination lens 5 to a region of reticle 6 which masks out part of the electron beam. Specifically, as the electron beam passes through reticle 6, portions of the electron beam are allowed to pass through reticle 6, while other portions of the electron beam may be scattered to prevent those portions from being focused onto a wafer 8. After passing through reticle 6, portions of the electron beam pass through projection lens 7 and onto wafer 8, where it forms a demagnified image of the illuminated part of the reticle. Reticle 6 is mounted on a reticle stage 16, and wafer 8 is mounted on a wafer stage 18. By a combination of stage movement and electromagnetic deflection of the electron beam, the entire pattern of the reticle is sequentially transferred to the wafer where the electrons expose an electron sensitive resist. After exposure, the resist on the wafer is developed, and regions of the resist exposed by the electrons are removed, for a positive type resist; or regions of the resist not exposed by the electrons are removed, for a negative type resist. The remaining resist forms a stencil mask, with which the mask features can be transferred into the wafer by etching or deposition processes. More information about electron beam projection lithography systems may be found, for example, in U.S. Pat. Nos. 5,079,112 and 5,466,904, which are incorporated herein by reference in their entireties.

In general, wafer 8 is mounted on wafer stage 18 to facilitate the movement of wafer 8 beneath projection lens 7. The design of a wafer stage for use in an electron beam projection system may be complicated, as an electron beam projection system generally must not include moving magnets or metals which alter the magnetic field associated with the electron beam projection system and, hence, the electron beam. As will be appreciated by those skilled in the art, reticle stage 16 generally also may not include moving magnets or metals which alter the magnetic field associated with the electron beam projection system.

Electron beam projection systems generally include a lens system that may dynamically move a projection image to follow a stage, which is generally not possible with other systems, e.g., an optical system, as will be appreciated by those skilled in the art. In addition, electron beam lens systems typically correct for relatively small errors in relative stage positions, whereas optical systems generally do not.

The use of air bearing guides to facilitate the movement of a wafer stage, e.g., a scanning stroke of the wafer stage, within a vacuum generally provides for relatively high stiffness, substantially no friction, and low noise while the air bearing guide moves over a guide surface. As will be appreciated by those skilled in the art, however, conventional air bearings often leak. In some cases, air flow leakage into a vacuum chamber from an air bearing guide may significantly reduce the vacuum level in a vacuum chamber. In general, the allowable leakage flow from an air bearing depends upon the acceptable vacuum level in a vacuum chamber, as well as the vacuum pumping capability associated with the vacuum chamber. Typically, for an electron beam projection system, desired vacuum levels are relatively high, e.g., on the order of approximately 10⁻⁶ Torr. Many conventional air bearings leak gas at flow rates many orders of magnitude above a tolerable, or acceptable, level for an electron beam projection system.

In general, in addition to electron beam projection systems which include wafer stages and reticle stages which may operate in a vacuum environment, there are many other types of systems which operate in a vacuum environment, and, as a result, may not operate as desired when conventional air bearings associated with the systems leak. Other types of systems include, but are not limited to, electron beam inspection machines, wafer repair machines, and reticle repair machines, as well as EUV lithography systems.

Typically the stages of all of the systems mentioned above require a high degree of precise motion. This is especially true for an EUV lithography system which must synchronize the position of the wafer and reticle stages to within nanometers in order to function effectively. The electron beam systems mentioned can compensate to a limited extent for stage motion errors by deflecting the electron beam appropriately. One source of motion perturbation of stages is drag and vibration from hoses and electrical cables attached to the stage. Consequently, the number of such hoses and cables should be reduced as much as possible.

Therefore, what is needed is a method and an apparatus for enabling wafers to be positioned efficiently and accurately within an electron beam projection system. That is, what is desired is an air bearing linear guide which does not allow for significant leakage, has a relatively long scanning stroke, and is suitable for use in a relatively high vacuum environment. Moreover, the stage design should preferably keep to a minimum the number and size of attached cables and hoses.

### SUMMARY OF THE INVENTION

The present invention relates to air bearing linear guides which have a stroke length that is substantially independent of a length associated with the air bearing linear guides, and are suitable for use in an environment with high vacuum levels. Moreover, the number of hoses needed by the linear guide may be substantially minimized. According to one aspect of the present invention, a guide bearing system includes a linear guide and a first guide beam. The linear guide has an inner surface which includes an air pad. The linear guide is wrapped around the first guide beam such that it may slide with respect to the guide beam. The guide beam includes a first chamber that is in fluid communication with the linear guide through at least one of a first plurality of ports in the guide beam which enable access to the first chamber.

In one embodiment, the linear guide is arranged to overlap, or encompass, a first port in the guide beam. When the linear guide substantially overlaps the first port, the first chamber is in fluid communication with the linear guide through the first port. In such an embodiment, the first port may be open, while a second port is substantially closed.

The use of multiple ports on a common surface of a guide beam enables the stroke length associated with a linear guide to be increased without increasing the size of the linear guide and, hence, the size of an overall apparatus which includes the linear guide. As the linear guide moves from one port to another, a mechanism such as a valve mechanism may open and close the ports as appropriate to allow pumping and to reduce the amount of gas that escapes from the interior of the guide beam. A port that is overlapped by the linear guide is generally open to enable appropriate areas of the linear guide to be in fluid communication with the interior of the guide beam, while ports that are not overlapped by the linear guide or are only partially overlapped by the linear guide are generally closed to substantially prevent gas from escaping from the guide beam.

According to another aspect of the present invention, a guide bearing system includes a linear guide with an air pad and a first guide beam which includes a first chamber with a first port. The linear guide is arranged to substantially wrap around the first guide beam and to slide with respect to the guide beam. The first port includes a first sealing arrangement that is arranged to control access to the first chamber. The first chamber is in fluid communication with the linear guide through the first port when the first sealing arrangement is arranged to enable access to the first chamber. In one embodiment, the first chamber further includes a second port with a second sealing arrangement that is arranged to control access to the first chamber through the second port.

In another embodiment, the first sealing arrangement includes a plate and a seal. The plate is arranged to hold the seal against a surface of the first guide beam to substantially prevent access to the first chamber through the first port. In such an embodiment, the first sealing arrangement may also include an actuator that provides a force on the plate to hold the seal against the surface.

According to still another aspect of the present invention, a method for scanning a stage that is coupled to an air bearing linear guide which slides over a guide beam which includes an internal chamber with at least a first exhaust port and a second exhaust port on a first side involves sliding the air bearing linear guide to overlap the first exhaust port. Once the air bearing linear guide overlaps the first exhaust port, the first exhaust port is maintained in a substantially open configuration to enable fluid communication between the air bearing linear guide and the internal chamber. The method also includes maintaining the second exhaust port in a substantially closed configuration when the air bearing linear guide does not overlap the second exhaust port to minimize fluid communication with the internal chamber through the second exhaust port.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of an electron beam projection lithography system which is contained within a vacuum chamber.

FIG. 2 is a diagrammatic three-dimensional representation of a wafer stage assembly which includes an air bearing linear guide, and is suitable for scanning a wafer table along two axes in accordance with an embodiment of the present invention.

FIG. 3a is a diagrammatic cross-sectional representation of a guide beam and an air bearing linear guide which is arranged to translate over the guide beam in accordance with an embodiment of the present invention.

FIG. 3b is a diagrammatic perspective representation of a guide beam, e.g., guide beam 302 of FIG. 3a, in accordance with an embodiment of the present invention.

FIG. 4 is a diagrammatic representation of a low-vacuum side of an air bearing linear guide and a guide beam in accordance with an embodiment of the present invention.

FIG. 5 is a diagrammatic representation of a high-vacuum side of an air bearing linear guide and a guide beam in accordance with an embodiment of the present invention.

FIG. 6a is a diagrammatic representation of an air bearing linear guide in a first position with respect to a guide beam in accordance with an embodiment of the present invention.

FIG. 6b is a diagrammatic representation of an air bearing linear guide, e.g., air bearing linear guide 400 of FIG. 6a, in a second position with respect to a guide beam, e.g., guide beam 420 of FIG. 6a, in accordance with an embodiment of the present invention.

FIG. 7 is a diagrammatic representation of an air bearing linear guide in three different position with respect to a guide beam with multiple ports on a first side in accordance with an embodiment of the present invention.

FIG. 8a is a diagrammatic cross-sectional side-view representation of a portion of guide beam which includes a plurality of exhaust ports in accordance with an embodiment of the present invention.

FIG. 8b is a diagrammatic cross-sectional side-view representation of a portion of guide beam, e.g., guide beam 820 of FIG. 8a, which includes an open exhaust port in accordance with an embodiment of the present invention.

FIG. 8c is a diagrammatic cross-sectional side-view representation of a portion of guide beam, e.g., guide beam 820 of FIG. 8a, which includes an open exhaust port in accordance with another embodiment of the present invention.

FIG. 9a is a diagrammatic cross-sectional side view representation of a guide beam which includes valve mechanisms that are arranged to control access to exhaust ports in accordance with an embodiment of the present invention.

FIG. 9b is a diagrammatic cross-sectional side view representation of a guide beam, e.g., guide beam 920 of FIG. 9a, which includes a valve mechanism that is open to enable access to an internal chamber of the guide beam in accordance with an embodiment of the present invention.

FIG. 10 is a diagrammatic representation of an air bearing linear guide which is sliding over a guide beam such that a portion of an exhaust port is overlapped by the air bearing linear guide in accordance with an embodiment of the present invention.

FIG. 11 is a diagrammatic representation of a photolithography apparatus in accordance with an embodiment of the present invention.

FIG. 12 is a process flow diagram which illustrates the steps associated with fabricating a semiconductor device in accordance with an embodiment of the present invention.

FIG. 13 is a process flow diagram which illustrates the steps associated with processing a wafer, i.e., step 1304 of FIG. 12, in accordance with an embodiment of the present invention.

FIG. 14 is a diagrammatic cross-sectional representation of a portion of a guide beam which includes exhaust port covers in accordance with another embodiment of the present invention.

FIG. 15 is a diagrammatic representation of an air bearing linear guide which is sliding over a guide beam with a slotted exhaust port in accordance with an embodiment of the present invention.

FIG. 16a is a diagrammatic cross-sectional representation of an air bearing linear guide which is sliding over a guide beam with an exhaust port which includes a parallel series of slots in accordance with an embodiment of the present invention.

FIG. 16b is a diagrammatic cross-sectional representation of an air bearing linear guide which is sliding over a guide beam with an exhaust port which includes a parallel series of slots, e.g., air bearing linear guide 1624 and exhaust port 1608 of FIG. 16a, such that one slot is exposed to a vacuum environment in accordance with an embodiment of the present invention.

FIG. 17a is a diagrammatic representation of a sliding exhaust port plate which is in an open position with respect to an exhaust port opening with slots in accordance with an embodiment of the present invention.

FIG. 17b is a diagrammatic representation of a sliding exhaust port plate, e.g., sliding exhaust port plate 1704 of FIG. 17a, which is in a closed position with respect to an exhaust port opening with slots in accordance with an embodiment of the present invention.

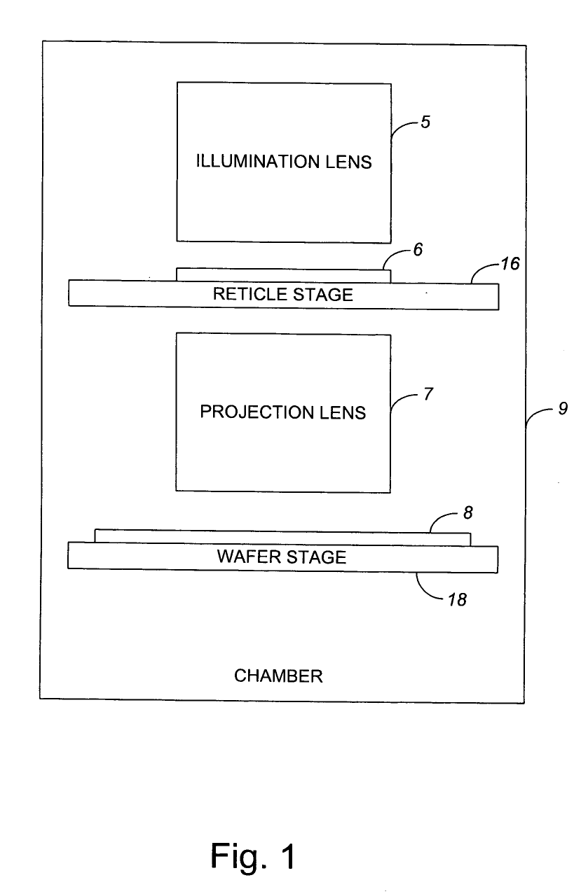

### DETAILED DESCRIPTION OF THE EMBODIMENTS

The configuration of a wafer stage or reticle stage which is suitable for use in a lithography apparatus such as an electron beam projection lithography system generally may not include conventional air bearings, as conventional air bearings typically leak. The leakage of air from air bearings into a vacuum chamber associated with an electron beam projection system would likely significantly increase the residual gas pressure in a vacuum chamber, thereby adversely affecting an overall electron beam lithography process. Since a conventional air bearing typically leaks at a flow rate many orders of magnitude above an acceptable level for an electron beam projection system, the use of a conventional air bearing may result in inaccuracies in photolithography processes.

An air bearing linear guide which does not leak a significant amount may be used in a vacuum chamber. Such an air bearing linear guide may generally include air flow evacuation stages which are incorporated into the linear guide in order to reduce the volume of gas which reaches the vacuum chamber and the volume of gas that is pumped out of the vacuum chamber. One embodiment of such a linear guide is described in co-pending U.S. patent application Ser. No. 09/642,080, filed Aug. 18, 2000, entitled “Air Bearing Linear Guide for Use in a Vacuum,” which is incorporated herein by reference in its entirety for all purposes. The air bearing linear guide described in U.S. patent application Ser. No. 09/642,080 is configured such that any leakage generally has an insignificant effect on the overall vacuum level. Specifically, for a vacuum level on the order of approximately 10⁻⁶ Torr, leakage from the air bearing linear guide is generally of an order of magnitude that would not impact the vacuum level. Each air pad of an air bearing linear guide may be surrounded by a channel which is vented substantially directly to atmospheric pressure. As such, each air pad may effectively operate as if it were in a non-vacuum environment, while the linear guide which includes the air pads operates in a vacuum. Therefore, the linear guide is able to operate within a vacuum with relatively unimpaired performance, an essentially negligible amount of friction, a relatively high stiffness, and low noise.

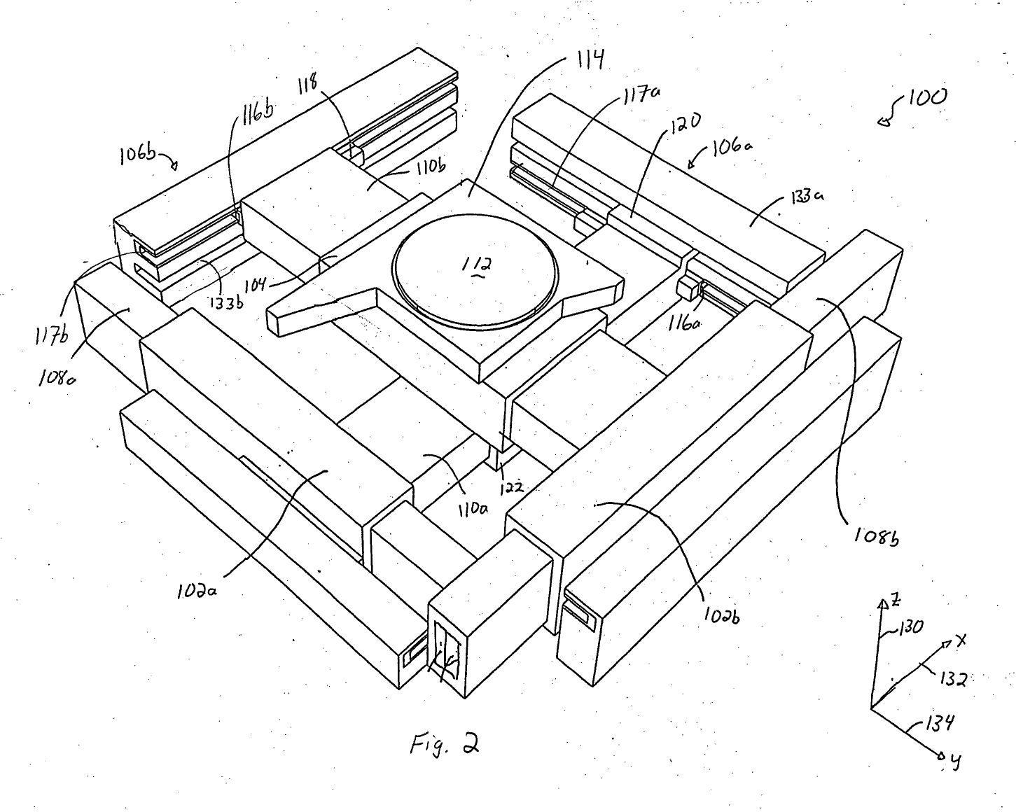

FIG. 2 is a diagrammatic three-dimensional representation of a wafer stage assembly which includes an air bearing linear guide, and is suitable for scanning a wafer table along two axes in accordance with an embodiment of the present invention. A wafer stage assembly 100, as described in U.S. patent application Ser. No. 09/642,080, is arranged to cause a wafer 112 situated on a table 114 to scan along an x-axis 132 and a y-axis 134. As will be understood by those skilled in the art, in some embodiments, wafer 112 may also be moved along a z-axis 130, e.g., through the use of servo motors (not shown) attached to either table 114 or entire assembly 100.

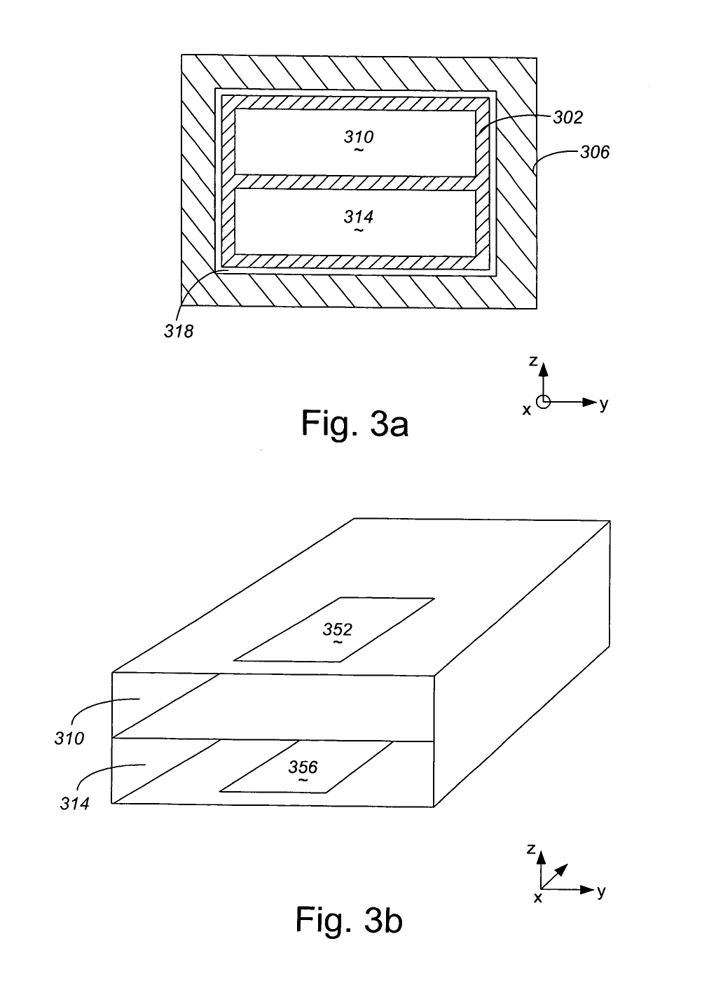

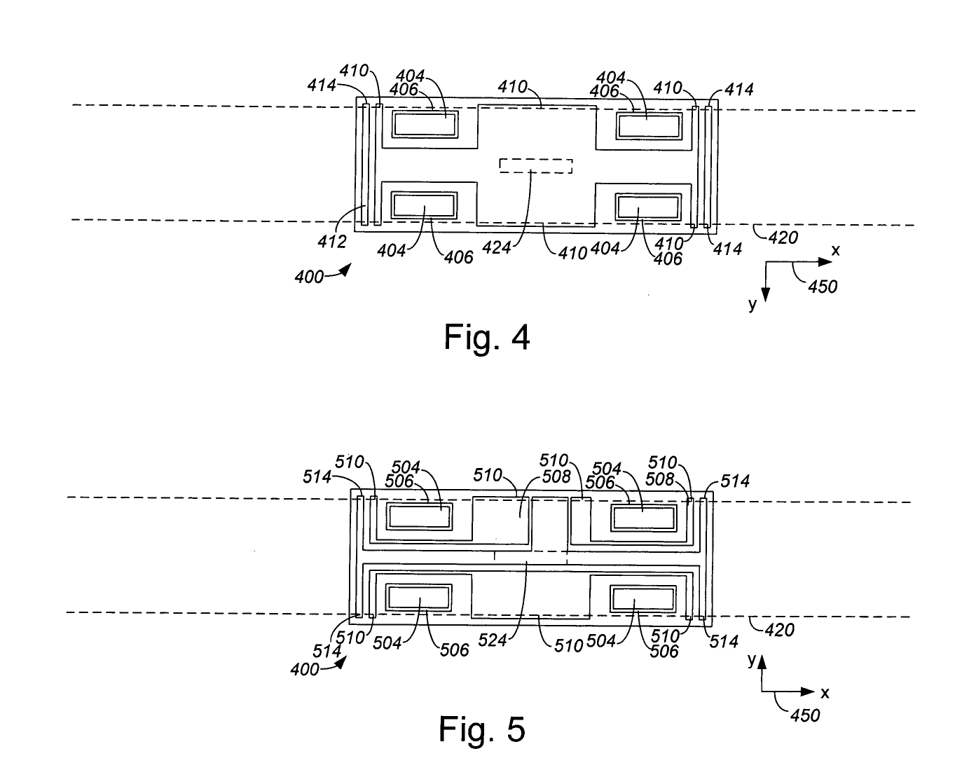

Table 114 is coupled, generally substantially fixably, to an air bearing linear guide 104. Air bearing linear guide 104, which may be considered to be an air bearing or a slider bearing, is arranged to move over a guide beam 110b which, in turn, is coupled to an air bearing linear guide 102b. Guide beam 110b is arranged such that an interior of the guide beam is arranged to be in fluid communication with air bearing linear guide 104 when a port (not shown) within guide beam 110b is aligned appropriately with air bearing linear guide 104. One embodiment of a guide beam will be discussed below with reference to FIGS. 3a and 3b, while the alignment of ports with an air bearing linear guide will be discussed below with respect to FIGS. 4, 5, 6a, and 6b.

Air bearing linear guide 104, or a slider, is coupled to guide beam 110b which is coupled to an extension section 118 that effectively moves within an air guide 133b in a guide section 106b. The guide beam 110b also includes a coil 116b. Guide beam 110b is supported along z-axis 130 and rotationally supported about y-axis 134 by extension section 118 and linear guide 102b. In addition, guide beam 110b is constrained from rotation about x-axis 132 and z-axis 134. A coil 116b of guide beam 110b moves within magnet array 117b to form a linear motor, while an extension of section 118 is arranged to move within air guide 133b. Hence, extension section 118 slides within guide section 106b and enables linear guide 102b to move over guide beam 108b.

Air bearing linear guide 104 is substantially fixably coupled to a cross bearing 122 which is arranged to move over a guide beam 110a. Cross bearing 122 may be arranged on guide beam 110a such that guide beam 110a may experience yaw, e.g., rotation about z-axis 130. In order for guide beam 110a to yaw, cross bearing 122 may include single air pads on substantially only the two vertical inner sides of cross bearing 122. This substantially minimizes the yaw stiffness, i.e., the rotational stiffness about z-axis 130, between cross bearing 122 and guide beam 110a. In addition, air pads on horizontal inner surfaces of cross-bearing 122 may be added for stiffness, or eliminated such that a stage made up of substantially only cross bearing 122 and linear guide 104 is effectively constrained along x-axis 132, along z-axis 130, about x-axis 132, about y-axis 134, and about z-axis 130 substantially only by linear guide 104.

As shown, guide beam 110a is coupled to an air bearing linear guide 102a, which is arranged to move over a guide beam 108a. In one embodiment, air bearing linear guide 102a has a similar structure to that of air bearing linear guide 102b, while guide beam 108a has a similar structure to guide beam 108b. Like guide beam 110b, guide beam 110a also has a coil 116a and an extension section 120 that is arranged to move within an air guide 133a in a guide section 106a. A coil 116a moves within magnet array 117a to form a linear motor.

Linear motors, as for example linear motors including moving coils and fixed magnet arrays 116, used to enable wafer 112 to move may be arranged such that magnet arrays 116 are substantially stationary, thereby reducing issues associated with moving magnets near an electron beam. While the linear motor coils are relatively large conductors, the linear motor coils may be positioned relatively far from an electron beam column, and may be well shielded by the magnet tracks associated with the linear motors, as well as by additional magnetic shielding. Further, while the linear motor coils may generate relatively large magnetic fields when energized, during scanning the amount of current used for accelerating may be small and as a result have very little effect on an electron beam.

Each linear guide in a wafer stage, e.g., each of linear guides 102, 104, and 122, generally operates in substantially the same manner. Specifically, the general flow configurations of linear air guides 102 and 104 are substantially the same, whereas the flow configuration of linear air guide 122 is similar to the configurations of linear air guides 102 and 104.

In general, a guide beam such as guide beam 108b includes substantially separate chambers through which a low vacuum flow and a high vacuum flow may occur. A low vacuum flow refers to a flow of gas at a chamber pressure corresponding to a low vacuum, and a high vacuum flow refers to a flow of gas at a chamber pressure corresponding to a high vacuum. Such chambers have exhaust ports which enable appropriate areas of a linear guide such as linear guide 102b to communicate with appropriate chambers in a guide beam. For example, a low vacuum region of linear guide 102b may be in fluid communication with a low vacuum chamber of guide beam 108b through a low vacuum exhaust port, while a high vacuum region of linear guide 102b may be in fluid communication with a high vacuum chamber of guide beam 108b.

FIG. 3a is a diagrammatic cross-sectional representation of a guide beam and an air bearing linear guide which is arranged to translate or slide over the guide beam in accordance with an embodiment of the present invention. A guide beam 302 is effectively a hollow beam which includes a first internal chamber 310 and a second internal chamber 314. First internal chamber 310 may contain a relatively low vacuum flow, while second internal chamber 314 may contain a relatively high vacuum flow. An air bearing linear guide 306 is positioned around guide beam 302 such that air bearing linear guide 306 is separated from guide beam 302 by a gap 318.

As shown in FIG. 3b, guide beam 302 may include a first exhaust port 352 which enables access to first internal chamber 310, and a second exhaust port 356 which enables access to second internal chamber 314. In general, when a low vacuum area (not shown) of air bearing linear guide 306 of FIG. 3a is positioned over exhaust port 352, low vacuum flow may pass between the low vacuum area and first internal chamber 310 through first exhaust port 352. Similarly, when a high vacuum area (not shown) of air bearing linear guide 306 of FIG. 3a is positioned or under exhaust port 356, high vacuum flow may pass between the high vacuum area and second internal chamber 314 through second exhaust port 356. Typically, the side of air bearing linear guide 306 which moves over first exhaust port 352 may be considered to be a “low-vacuum side” of air bearing linear guide 306, and the side of air bearing linear guide 306 which moves over second exhaust port 356 may be considered to be a “high-vacuum side” of air bearing linear guide 306.

FIG. 4 is a diagrammatic representation of a low-vacuum side of an air bearing linear guide and a guide beam in accordance with an embodiment of the present invention. An air bearing linear guide 400 is arranged to move substantially over a guide beam 420 along an x-axis 450. Along a surface of air bearing linear guide 400 which is effectively face-to-face with a first outer surface of guide beam 420, i.e., an inner surface of air bearing linear guide 400, air bearing pads 404 are arranged to be substantially positioned at a gap distance, as for example between approximately five microns and approximately seven microns, from guide beam 420, as discussed in U.S. patent application Ser. No. 09/642,080. Air bearing pads 404 are typically coupled to an air supply through a hose that supplies gas, e.g., air at a pressure of between approximately 60 pounds per square inch (psi) and approximately 80 psi. Grooves 406 which are positioned around air bearing pads 404 may contain a low vacuum of approximately half of an atmosphere (atm), or may provide an atmospheric pressure environment such that air bearing pads 404 effectively function as if air bearing pads 404 were not in a vacuum.

Air pads 404 are generally spaced to substantially minimize the length of linear guide 102b, e.g., the dimension of linear guide 102b along x-axis 132. By minimizing the length of linear guide 102b, the length of an associated guide beam, e.g., guide beam 108b of FIG. 2, may also be substantially minimized. Minimizing the length of the associated guide beam increases the torsional and bending stiffness associated with the guide beam.

In one embodiment, an atmospheric pressure environment, that is provided to enable air bearing pads 404 to function as if air bearing pads 404 were not in a vacuum, may be provided through the use of a hose (not shown) which may serve as both a source and a sink for the atmospheric pressure. That is, an exhaust hose (not shown) may be coupled to grooves 406 or, more generally, air bearing linear guide 400, to enable an atmospheric pressure environment to be provided to grooves 406 such that air bearing pads 404 may essentially operate as if air bearing pads 404 were operating under normal atmospheric pressure conditions.

The inner surface of air bearing linear guide 400 also includes a low vacuum area 408 and a high vacuum area 412. In one embodiment, low vacuum area 408 contains a vacuum in the range of approximately 0.1 Torr to approximately 1 Torr, while high vacuum area 412 contains a vacuum on the order of approximately 10⁻⁴ Torr. When low vacuum area 408 is positioned over a low vacuum exhaust port 424 in guide beam 420, low vacuum area 408 is in communication with an internal chamber of guide beam 420 to enable flow between low vacuum area 408 and a first internal chamber of guide beam 420. The first internal chamber of guide beam 420 may be evacuated by a vacuum pump chosen to operate efficiently at a low vacuum pressure.

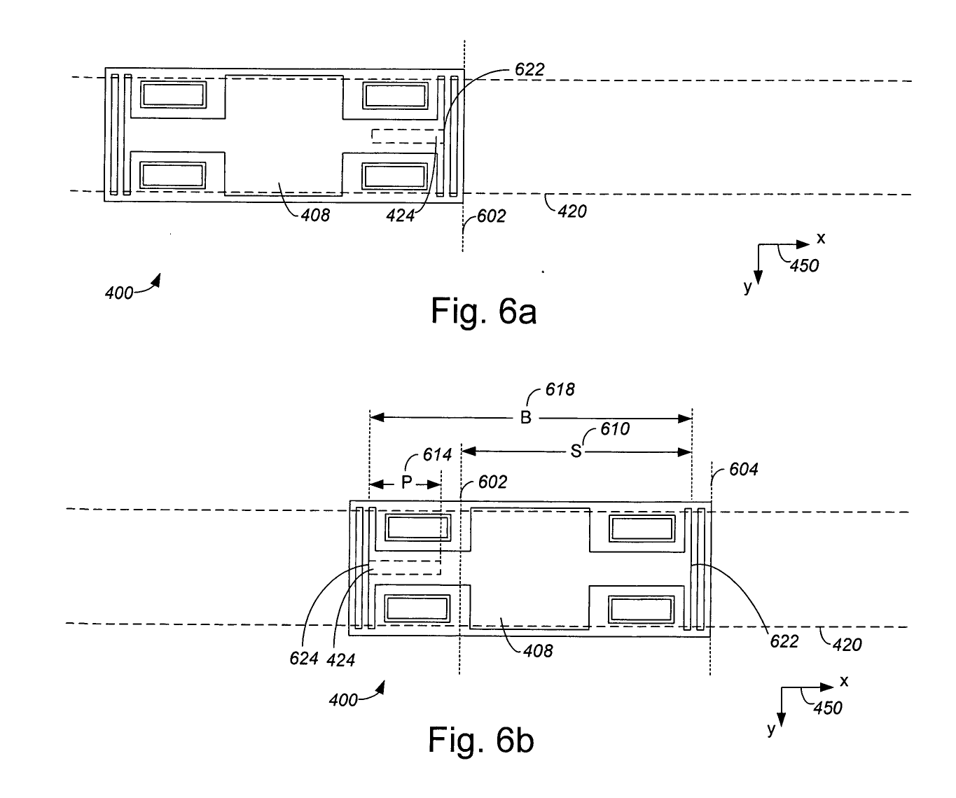

In general, a high-vacuum side (not shown) of air bearing linear guide 400 is arranged to be substantially face-to-face with a second outer surface of guide beam 420. That is, a low-vacuum side of air bearing linear guide 400 is arranged to contact one side of guide beam 420 while a high-vacuum side of air bearing linear guide 400 is arranged to contact an opposite side of guide beam 420. FIG. 5 is a diagrammatic representation of a high-vacuum side of a linear guide and a guide beam in accordance with an embodiment of the present invention. When air bearing linear guide 400 moves substantially over a guide beam 420 along an x-axis 450, air bearing pads 504, which are surrounded by grooves 506, are arranged to be positioned at a gap distance, or a flying height, from guide beam 420.

The inner surface of air bearing linear guide 400 includes low vacuum area 508 and a high vacuum area 512. While high vacuum area 512 is positioned over a high vacuum exhaust port 524 in guide beam 420 as shown, high vacuum area 512 is in communication with an internal chamber of guide beam 420 to enable flow between high vacuum area 512 and a second internal chamber of guide beam 420. The second internal chamber of guide beam 420 may be evacuated by a vacuum pump chosen to operate efficiently at a high vacuum pressure.

Low vacuum area 508 communicates with low vacuum area 408 on the opposite side of linear guide 400 through channels 410, 510 in the inner surface of the sides of linear guide 400. Air bearing pads (not shown), surrounded by grooves (not shown) similar to 406, 506, may be located on the inner sides of linear guide 400. High vacuum area 512 communicates with high vacuum grooves 412 on the opposite side of linear guide 400 through channels 414, 514 in the inner surface of the sides of linear guide 400. Thus, gas leakage from the air bearing pads is substantially contained and removed from the vacuum environment by means of grooves 406, 506 surrounding the air pads and communicating with atmospheric or near-atmospheric pressure through a hose, low vacuum areas 408, 508 communicating through a low vacuum exhaust port 424 in guide beam 420 to a low vacuum pump, and high vacuum area 512 communicating through a high vacuum exhaust port 524 in guide beam 420 to a high vacuum pump.

As described in U.S. Pat. No. 4,810,889, which is incorporated herein by reference in its entirety, each of these pressure regimes in a conventional system typically communicates with the interior of a bearing through external hoses attached to exhaust ports in a guide beam, e.g., guide beam 420. Thus, a minimum of four hoses external to the linear guide 400 are employed by the system described in U.S. Pat. No. 4,810,889. The sizes of these hoses will typically depend on the amount of gas flow required by bearing operation and by the conductance C of the hoses. The flow Q through a hose is given by the relation Q=CΔP, where ΔP is the difference in gas pressure at the two ends of the hose.

At relatively high gas pressures where the mean free path of a gas molecule is much smaller than the hose diameter, the gas flow is viscous, and the conductance C is proportional to gas pressure. At atmospheric pressure and above, for typical air bearings an adequate flow of gas to the bearing can be maintained with a small hose of inner diameter less than several mm. A hose of similar diameter may provide adequate exhaust flow from the grooves 406 surrounding the air bearing pads. However, at much lower pressures the hose conductance is reduced to such an extent that adequate exhausting of gases from low vacuum area 408 and high vacuum area 508 to their corresponding vacuum pumps typically utilizes hose diameters of an order of magnitude or more larger. Such hoses are heavy, bulky, and not very flexible. They create drag and vibration problems for the stages employing the bearings which are significantly more serious than those associated with the smaller hoses supplying the air bearing gas and exhausting it from grooves 406.

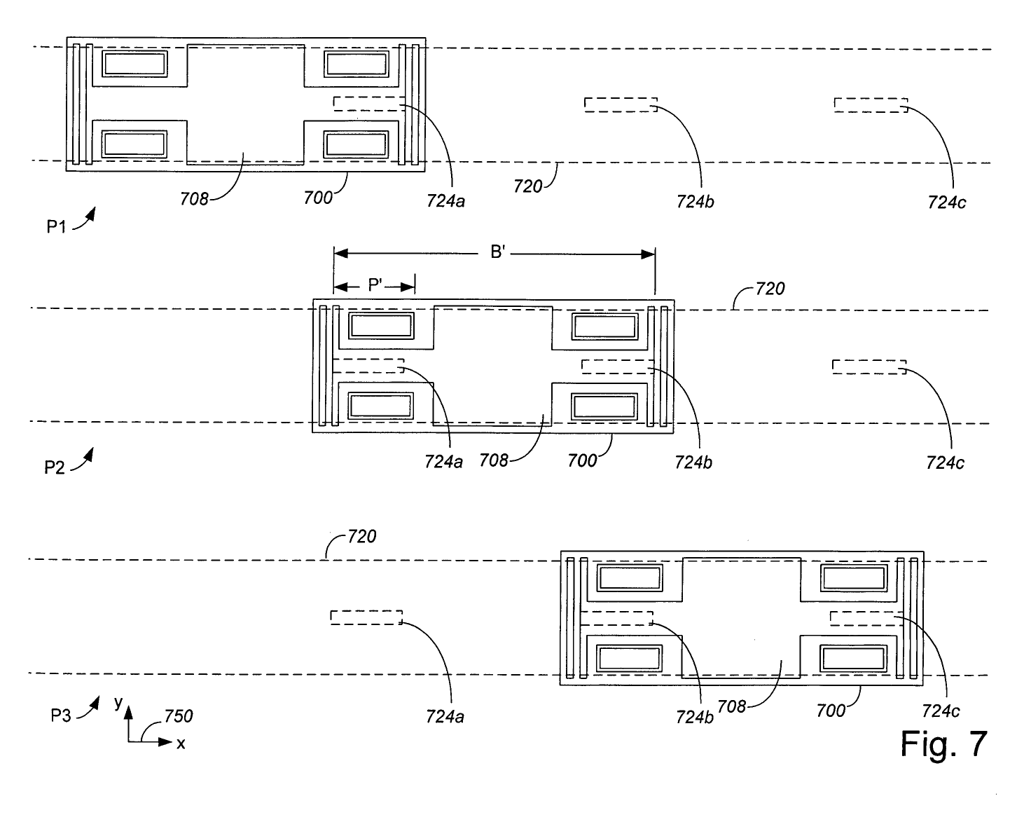

When a guide beam such as guide beam 420 of FIGS. 4 and 5 includes one low vacuum exhaust port and one high vacuum exhaust port, then the amount by which an air bearing linear guide may move is substantially limited by the length of the air bearing linear guide. In other words, the stroke length of the air bearing linear guide which operates using a guide beam with a single low vacuum exhaust port and a single high vacuum exhaust port is substantially constrained by the length of the air bearing linear guide since the low vacuum area of the air bearing linear guide effectively needs to be aligned over the low vacuum exhaust port and, further, the high vacuum area of the air bearing linear guide effectively needs to be aligned over the high vacuum exhaust port. With reference to FIGS. 6a and 6b, the stroke length of an air bearing linear guide will be described in accordance with an embodiment of the present invention. For ease of discussion, the stroke length of an air bearing linear guide will be describe in terms of a low vacuum area of the air bearing linear guide and a low vacuum exhaust port of a guide beam.

As shown in FIG. 6a, air bearing linear guide 400 is oriented with respect to guide beam 420 such that low vacuum exhaust port 424 is substantially aligned with a first edge 622 of low vacuum area 408. When low vacuum exhaust port 424 is aligned with first edge 622, air bearing linear guide 400 is positioned such that a leading edge of air bearing linear guide 400 is in a first position 602 with respect to x-axis 450. Moving air bearing linear guide 400 in a positive direction along x-axis 450 enables low vacuum area 408 to remain positioned over low vacuum exhaust port 424.

When the leading edge of air bearing linear guide 400 is in a second position 604, a second edge 624 of low vacuum area 408 is substantially aligned with low vacuum exhaust port 424, as shown. A distance between first edge 622 and second edge 624 along x-axis 450 may be designated as distance ‘B’ 618, while a length of low-vacuum exhaust port 424 along x-axis 450 may be designated as distance ‘P’ 614. An overall stroke length ‘S’ 610 associated with air bearing linear guide 400 is the distance between first position 602 and second position 604, or the difference between distance ‘B’ 618 and distance ‘P’ 614. As a result, for a given or desired stroke length ‘S’ 610, there is essentially a minimum size or overall length along x-axis 450 for an air bearing linear guide 400.

In order to achieve a longer stroke length ‘S’ 610, a larger air bearing linear guide and, hence, a larger overall stage apparatus may be needed. By way of example, to increase stroke length ‘S’ 610, distance ‘B’ 618 and, hence, the overall length of air bearing linear guide 400 may be increased. Significantly increasing the size and the weight of air bearing linear guide 400 and, hence, the overall stage apparatus which includes air bearing linear guide 400 and guide beam 420, is often undesirable. For example, a larger overall stage apparatus may be inefficient and relatively expensive to manufacture and maintain, as a larger air bearing linear guide 400 may require a more powerful actuator to drive air bearing linear guide 400, and larger reaction forces may be generated.

Air bearings designed in accordance with conventional systems generally do not require the linear guide dimensions to depend on the stage stroke. However, as the length of the stage stroke increases, typically the length of the hoses associated with the air bearing increases, adding to the problems of drag and vibration. Thus, conventional air bearings also are affected adversely by increased stage stroke.

Alternatively, in order to achieve a longer stroke length for an air bearing linear guide substantially without increasing the length of the air bearing linear guide, a series of exhaust ports which may be opened and closed as appropriate may be arranged on a guide beam. If such exhaust ports are spaced apart such that at least one exhaust port is substantially overlapped by an associated vacuum area, e.g., at least one low vacuum exhaust port is overlapped by a low vacuum area of an air bearing linear guide, at any given time, then the stroke length associated with the air bearing linear guide is effectively decoupled from the length of the air bearing linear guide. Instead, the stroke length may be lengthened by adding additional exhaust ports to a guide beam.

Exhaust ports of a guide beam may be arranged such that valves inside the guide beam open and close the exhaust ports appropriately as an air bearing linear guide moves or slides over the guide beam. By allowing exhaust ports to be opened and closed, pumping of gas through an open port may occur when needed, and gas within the guide beam may be substantially prevented from escaping into the environment, i.e., a relatively high vacuum environment, by closing ports as appropriate.

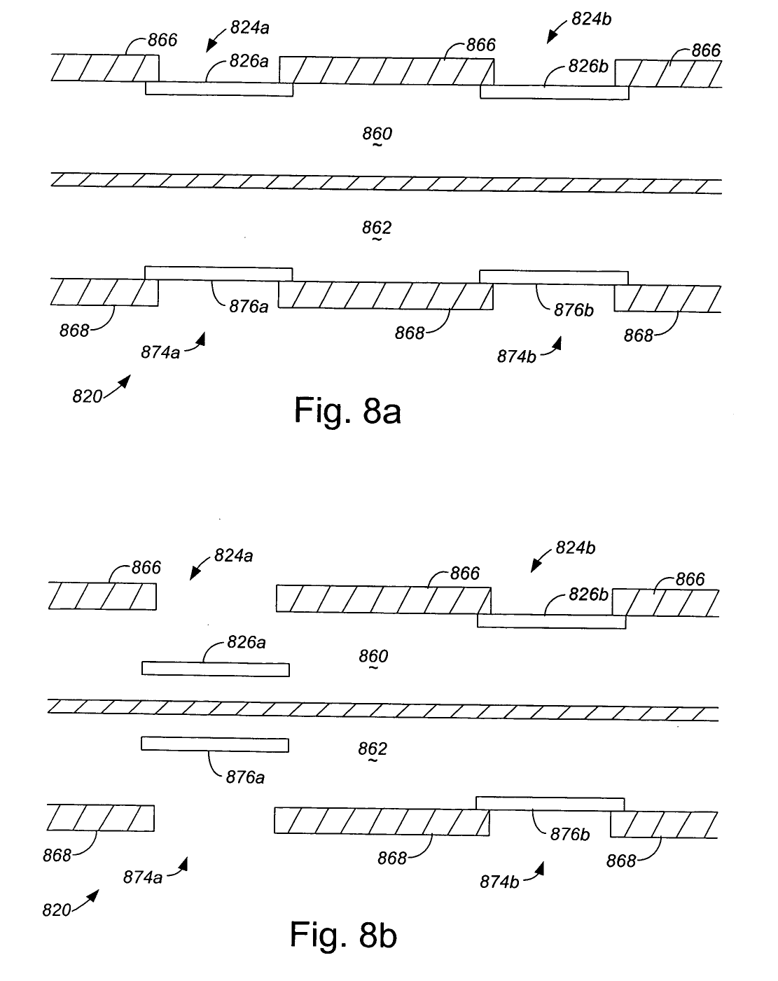

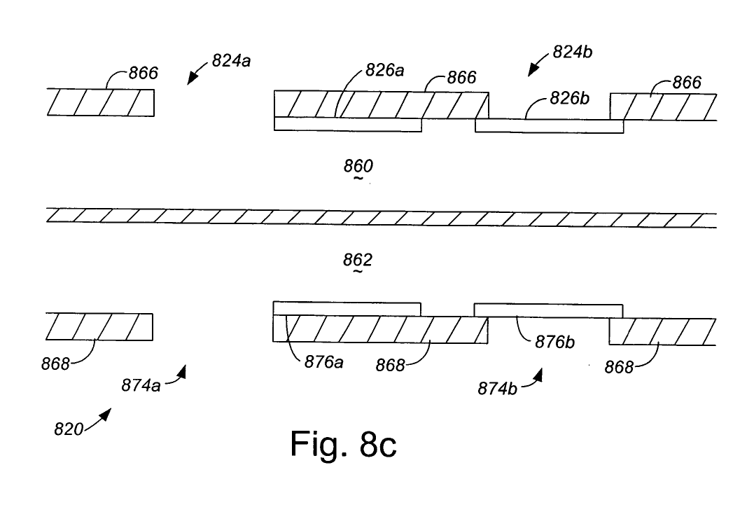

With reference to FIG. 7, a guide beam which includes multiple exhaust ports will be described in accordance with an embodiment of the present invention. FIG. 7 shows an air bearing linear guide 700 in three different positions with respect to a guide beam 720. A surface of guide beam 720 includes at least three exhaust ports 724. As will be discussed below with respect to FIGS. 8a-8c, exhaust ports 724 include covers or sealing plates which allow exhaust ports 724 which are effectively not in use to be sealed.

When air bearing linear guide 700 is in a first position P1, a vacuum area 708, e.g., a low vacuum area or a high vacuum area, is positioned substantially such that vacuum area 708 overlaps exhaust port 724a. Specifically, port 724a is substantially encompassed by an outline of vacuum area 708. While air bearing linear guide 700 is in first position P1, exhaust port 724a is open to enable flow between vacuum area 708 and a chamber (not shown) within guide bar 720. Since vacuum area 708 does not overlap exhaust ports 724b, 724c when air bearing linear guide 700 is in first position P1, exhaust ports 724b, 724c are closed or otherwise covered to substantially prevent exhaust ports 724b, 724c from leaking.

Air bearing linear guide 700 is in a second position P2 when vacuum area 708 overlaps both exhaust port 724a and exhaust port 724b, i.e., when exhaust port 724a and exhaust port 724b both are encompassed by an outline or footprint associated with vacuum area 708. In the described embodiment, since second position P2 is essentially displaced in a positive x-direction 750 from first position P1, vacuum area 708 overlaps both exhaust port 724a and exhaust port 724b as a result of vacuum area 708 moving over exhaust port 724a in a positive x-direction 750. As such, when air bearing linear guide 700 is in second position P2, exhaust port 724b may be in the process of opening while exhaust port 724 is in the process of closing. It should be appreciated that when air bearing linear guide 700 moves in a negative x-direction 750 to arrive at second position P2, exhaust port 724a may be in the process of opening while exhaust port 724b is in the process of closing. While air bearing linear guide 700 is in second position P2, exhaust port 724c remains effectively closed or sealed.

When air bearing linear guide 700 is in a third position P3, exhaust port 724b and exhaust port 724c are overlapped by vacuum area 708. Exhaust port 724a is essentially sealed substantially any time that vacuum area 708 does not overlap exhaust port 724a. Hence, while air bearing linear guide 700 is in third position P3, exhaust port 724a is essentially sealed. When exhaust port 724b and exhaust port 724c are overlapped by vacuum area 708 when third position P3 is achieved due to movement of air bearing linear guide 700 in a positive x-direction 750, then exhaust port 724b may in the process of closing while exhaust port 724c is in the process of opening. Alternatively, when third position P3 is achieved due to movement of air bearing linear guide 700 in a negative x-direction 750, then exhaust port 724b may be in the process of opening while exhaust port 724c is in the process of closing.

Typically, exhaust ports 724 are positioned along guide beam 720 such that there is substantially always at least one exhaust port 724 that is substantially completely overlapped by vacuum area 708 to ensure that fluid communication between vacuum area 708 and an internal chamber (not shown) of guide beam 720 that is accessible through exhaust ports 724 is effectively continuous. In one embodiment, adjacent exhaust ports 724, as for example exhaust ports 724a, 724b, may be spaced such that when an edge of exhaust port 724a is in contact with an edge of vacuum area 708, an edge of exhaust port 724b is in contact with a substantially opposite edge of vacuum area 708. That is, the distance between opposite ends of exhaust ports 724a, 724b with respect to x-direction 750 may be substantially the same as the distance between opposite ends of vacuum area 708 with respect to x-direction 750. However, the distance between opposite ends of exhaust ports 724a, 724b with respect to x-direction 750 may also be less than the distance between opposite ends of vacuum area 708 with respect to x-direction 750. This would provide more time for the ports 724 to open and close while remaining within the vacuum area 708 as the stage moves in the x-direction 750.

The stroke length associated with air bearing linear guide 700 may be varied by increasing the number of exhaust ports 724 associated with guide beam 720. By way of example, the stroke length of air bearing linear guide may be expressed as follows:
Stroke Length=(N−1)*(B′−P′)
where N is the number of exhaust ports 724 which are arranged to be potentially passed over by vacuum area 708, B′ is the length of vacuum area 708 with respect to x-direction 740, and P′ is the length of each exhaust port 724. Although each exhaust port 724 is typically of the same length, it should be appreciated that in some embodiments, the length of exhaust ports 724 may vary.

FIG. 8a is a diagrammatic cross-sectional side-view representation of a portion of guide beam which includes a plurality of exhaust ports in accordance with an embodiment of the present invention. A first surface 866 of a guide beam 820 includes exhaust ports 824 which are arranged to be enable fluid communication with an internal chamber 860 of guide beam 820 therethrough when covers 826 are not in position. As shown, covers 826 are in position to effectively seal exhaust ports 824 and, hence, prevent significant leakage through exhaust ports 824. Similarly, a second surface 868 of guide beam 820 includes exhaust ports 874 which, as shown, are effectively sealed by covers 876. In general, exhaust ports 874 are arranged to enable fluid communication with an internal chamber 862 of guide beam 820 therethrough when covers 876 are not in position.

When an exhaust port 824, 874 is to be opened, a cover 826, 876 may be moved such that flow may occur through exhaust port 824, 874 with adequate conductance, e.g., conductance which is not significantly inhibited by the presence of a cover 826, 876. By way of example, as shown in FIG. 8b, when exhaust port 824a is to be opened, cover 826a which is arranged to substantially seal exhaust port 824a may be “dropped” or otherwise moved into internal chamber 860 such that flow through exhaust port 824a is not significantly affected by the presence of cover 826a. Similarly, when exhaust port 874a is to be opened, cover 876a is “raised” or otherwise moved into internal chamber 862 such that flow through exhaust port 874a has adequate conductance with respect to flowing through chamber 862.

Typically, when cover 826a is moved from port 824a, the indication is that an appropriate vacuum area of an air bearing linear guide is positioned over exhaust port 824a. In lieu of dropping cover 826a into internal chamber 860, cover 826a may instead be repositioned near first surface 866. As shown in FIG. 8c, cover 826a may be positioned, e.g., slid, against first surface 866 to enable exhaust port 824a to be opened.

In the figures, ports 824 and 874 are shown as being positioned at substantially the same locations along the guide beam axis. The ports to both the low vacuum region of the guide beam and the high vacuum region of the guide beam open and close at substantially the same times. However, it should be appreciated that ports generally do not need to be placed at the same locations. For example, ports may instead be offset from one another. Offsetting the ports may be advantageous in some embodiments, because such positioning may afford greater vertical space for the installation of a port sealing mechanism. As long as the distances separating the ports along the guide beam axis remain substantially the same as the distances when ports are positioned at the same locations along the guide beam axis , the bearing will continue to function as before. However, the ports to the low vacuum region will no longer open and close at the same times as the ports to the high vacuum region.

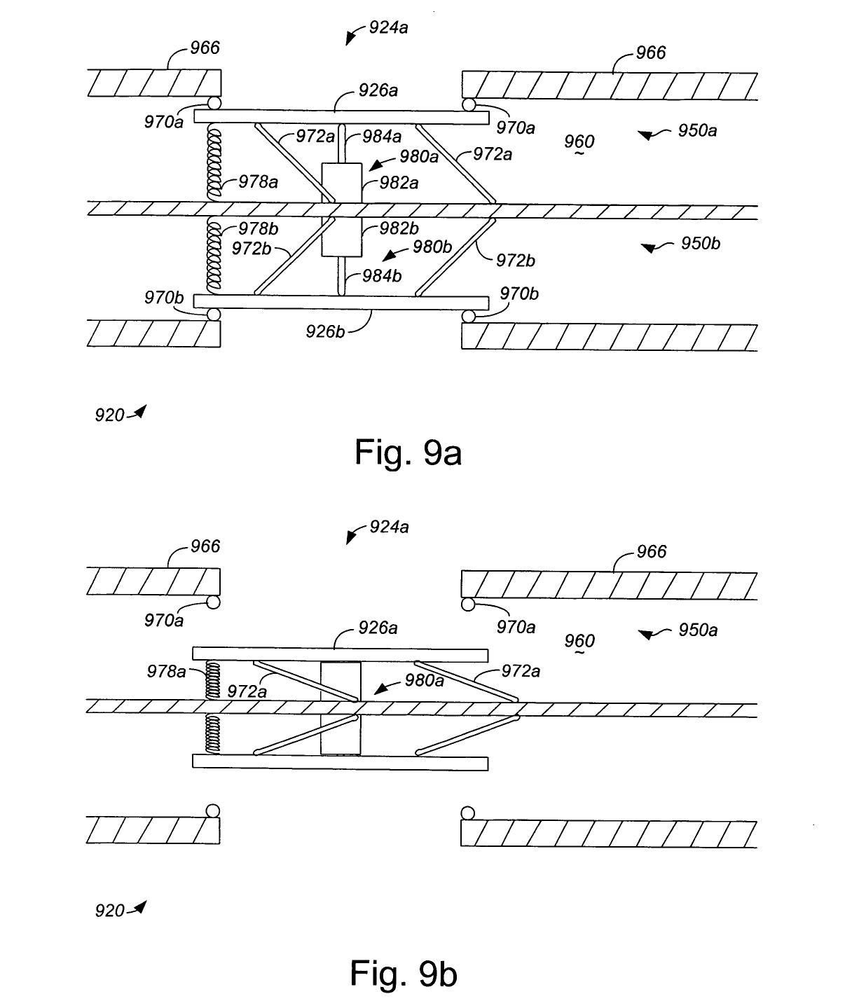

The mechanism used to enable cover 826a to substantially seal an exhaust port 824a while being retractable such that exhaust port 824a may effectively be opened may be widely varied. In one embodiment, cover 826a may be a part of a valve mechanism. With reference to FIGS. 9a and 9b, an embodiment of a valve mechanism which is suitable for use to control access to an exhaust port will be described in accordance with an embodiment of the present invention. FIG. 9a is a diagrammatic cross-sectional side view representation of a guide beam which includes valve mechanisms that are arranged to control access to exhaust ports. A valve mechanism 950 includes a plate 926, a seal 970, a linkage 972, a spring 978, and an actuator 980 which is arranged to open and to close valve mechanism 950. Plate 926 is arranged such that plate 926 cooperates with seal 970 to effectively close off exhaust port 924. As shown, actuator 980a may be actuated to provide a force on plate 926a to hold seal 970a, e.g., an o-ring seal seated in a groove or a gasket made of pliant material that is held in place by an adhesive material, against a first surface 966 of guide beam 920 to substantially prevent a significant amount of flow from leaking between plate 926a and first surface 966 when valve mechanism 950a is in a sealed position. Linkage 972, which may be a parallelogram linkage, is generally arranged to cooperate with actuator 980 to provide support for plate 926.

It should be appreciated that when valve mechanism 950a is in a sealed position, the overall strength of a seal formed using plate 926a, seal 970a, and first surface 966 may be relatively low. That is, the sealing force associated with plate 926a, seal 970a, and first surface 966 may be on the order of a few pounds, since there is no significant macroscopic pressure drop across valve mechanism 950a between internal chamber 960 and an exterior of guide beam 920. As a result, the forces provided by valve mechanism 950a may be relatively low, and the sealing force needed to prevent significant leakage through valve mechanism 950a is generally low enough such that distortions or vibrations of guide beam 920 due to valve actuation are effectively negligible.

When valve mechanism 950a is a relatively high vacuum valve, e.g., when internal chamber 960 is a high vacuum chamber, a gap (not shown) may exist either between seal 970a and plate 926a or between seal 970a and first surface 966. When a gap distance associated with such a gap is on the order of a few microns or less, any leakage through the gap will generally have an insignificant effect on the surrounding vacuum. Thus, the force used to effectively seal a high vacuum valve is generally very small.

Actuator 980a may include a body 982a and an extension 984a which is arranged to extend and to retract such that plate 926a may be moved within internal chamber 960. When extension 984a retracts, spring 978a typically compresses, as will be discussed below with respect to FIG. 9b, such that plate 926a may be pulled into internal chamber 960.

In general, actuator 980a may be substantially any suitable type of actuator. For example, actuator 980a may be an electromagnetic actuator or a pneumatic actuator. Since electromagnetic fields within an overall electron beam projection system may be problematic when the fields are in relatively close proximity to an electron beam, when an electromagnetic actuator is used, the electromagnetic actuator is typically well-shielded, to reduce any affect of the fields associated with the electromagnetic actuator on the electron beam.

In the described embodiment, valve mechanism 950a is an active valve. When valve mechanism 950a is an active valve, actuator 980a may be controlled using a stage controller, or a controller which controls an overall wafer stage which includes valve mechanism 950a. Such a controller is generally aware of the position of an air bearing linear guide with respect to exhaust port 924a and, hence may send signals to actuator 980a to valve mechanism 950a to opened and to close exhaust port 924a as appropriate. Alternatively, sensors located at or near actuators 980 may sense the location of the linear guide directly, allowing the valves to be controlled locally by relatively simple means. For example the sensors may detect permanent magnets located at appropriate positions on the linear guide.

When exhaust port 924a is to be opened, extension 984a of actuator 980a may be retracted, and spring 978a may be compressed, as shown in FIG. 9b. Spring 978a effectively pulls plate 926a down into internal chamber 960 in response to the retraction of extension 984a. In addition, linkage 972a may move such that linkage 972a continues to support plate 926a. Seal 970a may be coupled, as for example through the use of an adhesive material, to first surface 966. Alternatively, seal 970a may be coupled to plate 926a.

Plate 926a may generally be formed from any suitable material. Typically, plate 926a is formed from substantially the same material that is used to form guide beam 920, although it should be appreciated that materials used to form plate 926a may not necessarily be the same as materials used to form guide beam 920. Suitable materials for plate 926a include, but are not limited to, ceramic, alumina, silicon carbide, silicon nitride, and non-ferromagnetic metals.

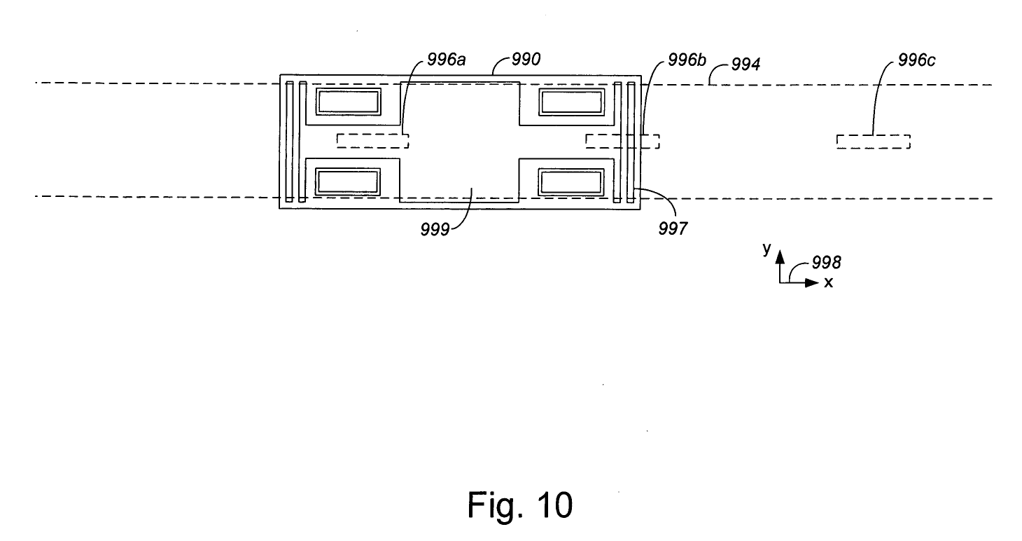

Covers or plates which are used to substantially seal exhaust ports are often recessed with respect to the outer surface of a guide beam. As a result, when an air bearing linear guide or a slider moves such that part of a sealed exhaust port is covered by the air bearing linear guide while a portion of the sealed exhaust port is not, a pocket of gas contained within the recess above the plate may be released into the overall vacuum environment. In addition, gases associated with channels in the air bearing linear guide may also leak out into the surrounding environment through the recess. FIG. 10 is a diagrammatic representation of an air bearing linear guide which is sliding over a guide beam such that a portion of an exhaust port is overlapped by the air bearing linear guide in accordance with an embodiment of the present invention. An air bearing linear guide 990 is arranged to move or slide over a guide beam 994 in an x-direction 998. As described above with respect to FIG. 7, exhaust ports 996 may open and close, as appropriate, as air bearing linear guide 990 moves over exhaust ports 996. When an exhaust port 996 is closed, a cover (not shown) of the exhaust port 966 may be recessed such that the cover is positioned below a top surface of guide beam 994.

When air bearing linear guide 990 moves in a negative x-direction 998 and is in a position as shown, exhaust port 996a may be open, while exhaust port 996b may be closed. In the embodiment as shown, exhaust port 996b was previously substantially completely overlapped by air bearing linear guide 990, since air bearing linear guide 990 is moving in a negative x-direction 998. As a result, there may be a pocket of gas, i.e., gas which is at approximately the same vacuum level as gas contained within a chamber (not shown) of guide beam which is accessible through exhaust ports 966, present in the recessed area associated with exhaust port 996b. Hence, the pocket of gas may effectively escape into the environment surrounding air bearing linear guide 990 and guide beam 994 when air bearing linear guide 990 is positioned such that at least a part of exhaust port 996b, which was previously overlapped by air bearing linear guide 990, is no longer overlapped.

Further, since an interior surface of air bearing linear guide 990 is positioned at a gap distance or a flying height above the exterior surface of guide beam 994, some gases flowing through air bearing linear guide 990 may leak out of air bearing linear guide 990 through the recess associated with exhaust port 996b. When air bearing linear guide 990 is stopped such that exhaust port 996b is partially exposed, some leakage of gases associated with air bearing linear guide 990 may occur.

In an electron beam projection system, the gas leakage which occurs as a result of a sealed exhaust port 996b being partially overlapped by air bearing linear guide 990 may be made negligible by proper design of the exhaust port covers. When the vacuum environment around air bearing linear guide 990 is on the order of approximately 10⁻⁶ Torr, the leakage which occurs through the recess positioned over exhaust port 996b is effectively negligible, as the leakage may be made generally at least an order of magnitude or more below that which would be likely to affect the vacuum environment of approximately 10⁻⁶ Torr. In the event that the vacuum environment around air bearing linear guide 990 is on the order of approximately 10⁻⁹ Torr or 10⁻¹⁰ Torr, or it is otherwise desirable to reduce the amount of leakage, then the parameters associated with guide beam 994 may be adjusted to reduce leakage. By way of example, at least one of the length, width, and height of the recess over each exhaust port 996 may be adjusted to enable any leakage which may occur to be compatible with chamber pressure requirements. Also, sealing forces may be increased to reduce residual gas leaks through gaps between the seals and the contacting surfaces. Alternatively, additional pumping capabilities may be provided within the overall system.

Gas from a high vacuum groove 997, which may be at a first pressure, may leak into the vacuum environment around air bearing linear guide 990. In addition, gas from a low vacuum groove 999, which may be at a second pressure that is an initial pressure, has a leakage path into the vacuum environment. Often, the gas from low vacuum groove 999, which crosses high vacuum groove 997 as it leaks, may be pumped by a high vacuum pump (not shown) coupled to high vacuum groove 997 and, hence, may not reach the vacuum environment, or only a small remnant of the original amount of gas may reach the vacuum environment. As such, gas which leaks from low vacuum groove 999 may not significantly increase the leakage to the vacuum environment, given the orders of magnitude difference between the pressure of the gas that leaks from high vacuum groove 997 and the gas that leaks from low vacuum groove 999. However, the effect of leakage from low vacuum groove 999 is generally greater than the leakage from high vacuum groove 997, since the amount of gas from low vacuum groove 999 that crosses high vacuum groove 997 and is pumped into high vacuum groove 997 may be sufficient to raise the local pressure of the gas which leaks from high vacuum groove 997.

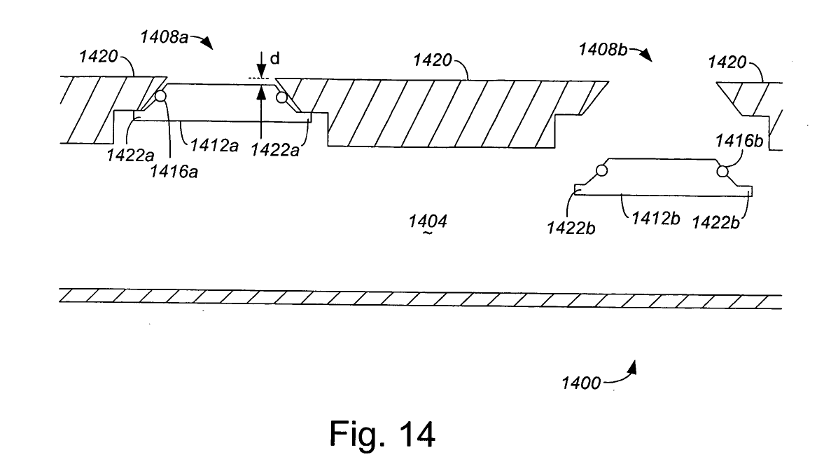

In order to reduce any leakage which may result when part of a closed exhaust port such as exhaust port 996b is exposed while an air bearing linear guide 990 passes over exhaust port 996b, a depth of a recess associated with exhaust port 996b may be reduced. In other words, the distance between a top of a surface of a guide beam and the top of a surface of a plate which covers an exhaust port may be reduced, as a relatively significant leakage may occur when the depth of a recess has a value in excess of the order of tens of microns. The depth, for example, of a recess over exhaust port 996 may be adjusted in order to substantially limit the flow through the depth of the recess even when exhaust port 996b is closed. In one embodiment, in order to adjust the height of a recess, the shape of a plate which is arranged to cover a port may be adjusted. FIG. 14 is a diagrammatic cross-sectional representation of a portion of a guide beam which includes exhaust port covers in accordance with another embodiment of the present invention. A guide beam 1400 includes a vacuum chamber 1404 and two exhaust ports 1408. As shown, exhaust port 1408a is substantially sealed by a plate 1412a, while exhaust port 1408b is open with plate 1412b being substantially dropped into chamber 1404.

When plate 1412a seals exhaust port 1408a, a seal 1416a, e.g., an o-ring seal seated in a groove or a gasket attached to one of the surfaces, contacts sides of a first surface. A depth ‘d’ of a recess above plate 1412a is substantially dependent upon how flanges 1422a of plate 1412a come into contact with first surface 1420. By increasing the thickness of flanges 1422a while maintaining an overall thickness of plate 1412a, depth ‘d’ may be increased. In general, flanges 1422a and plate 1412a may have substantially any suitable shape which allows exhaust port 1408a to be appropriately sealed. It should be appreciated that by decreasing depth ‘d’, the amount of leakage which may result from a pocket of gas contained within the recess when port 1408a is closed may be reduced.

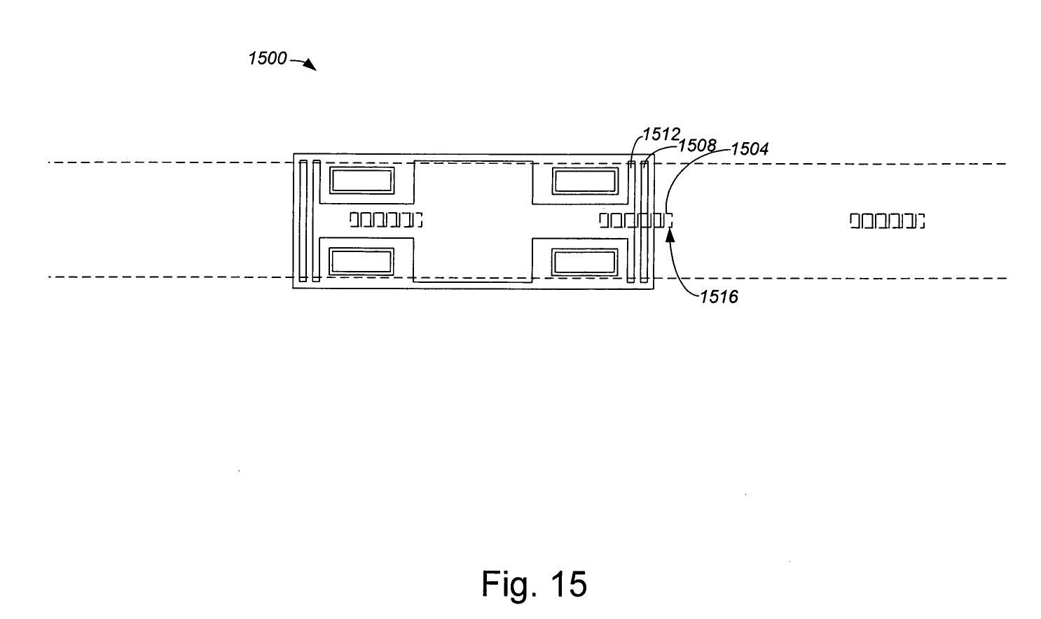

In lieu of adjusting the depth of a recess above a plate which covers an exhaust port or, in one embodiment, in addition to adjusting the depth of the recess, an exhaust port design in which a port opening is effectively a substantially parallel array of slots, is shown in FIG. 15. An array of slots 1504 in an exhaust port 1516 may generally enable a high vacuum groove 1508 and a low vacuum area 1512 of an air bearing linear guide 1500 to remain substantially isolated as they slide over slots 1504 in port 1516. Additionally, the use of slots 1504 may enable relatively small pockets of gas trapped within each closed slot to be released into a surrounding vacuum environment at a pressure that is approximately equivalent to the pressure of gas in high vacuum groove 1508, which may not significantly affect the vacuum level of the vacuum environment.

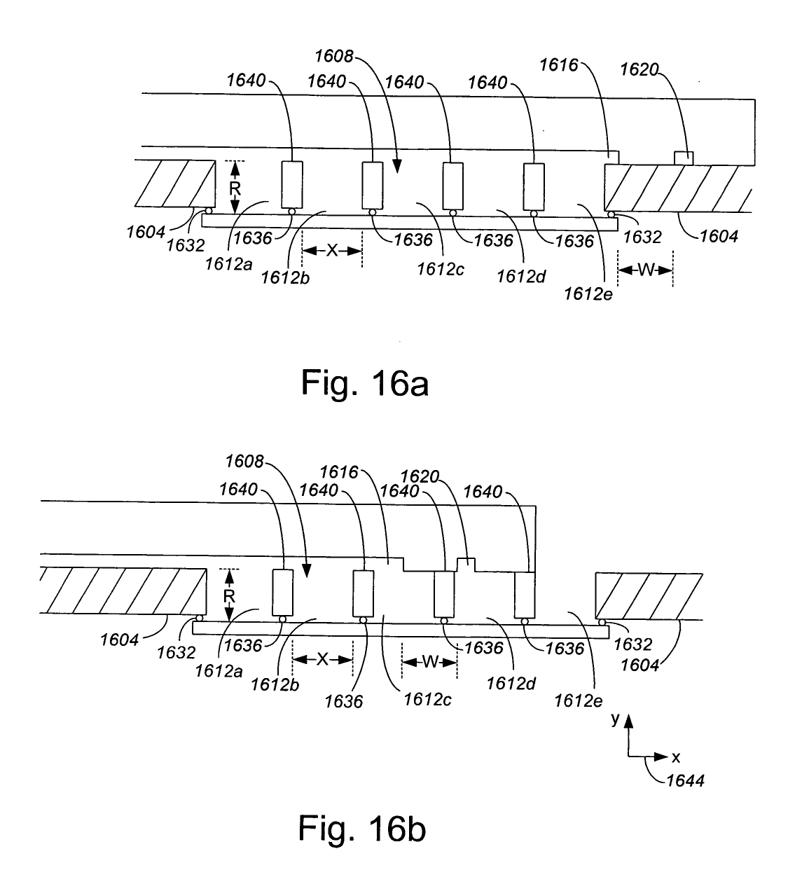

With reference to FIGS. 16a and 16b, a guide beam with exhaust ports which are a parallel series of slots will be described in more detail in accordance with an embodiment of the present invention. A first surface of a guide beam 1604 has an exhaust port 1608 defined therein which includes a plurality of slots 1612. In general, the number of slots 1612 within exhaust port 1608 may vary depending upon factors which may include, but are not limited to, the overall size of exhaust port 1608 and conductance requirements associated with exhaust port 1608.

Slots 1612 are substantially separated by dividers 1640 which, in one embodiment, may be in contact with a sealing plate 1628 through seals 1636 when plate 1628 is in a closed position, as shown, while first surface of guide beam 1604 is in contact with plate 1628 through a seal 1632. Seals 1632 and 1636 may be combined into a single gasket seal. A spacing ‘X’ between each slot 1612 is generally less than or approximately equal to a separation ‘W’ between a low vacuum area 1616 and a high vacuum groove 1620 in a linear guide 1624. By maintaining spacing ‘X’ for each slot 1612, high vacuum groove 1620 and low vacuum area 1616 may remain substantially isolated as groove 1620 and area 1616 slide over slots 1612, as previously mentioned.

As linear guide 1624 translates, slots 1612 may be exposed to the vacuum environment that exists external to linear guide 1624 and first surface of guide beam 1604. FIG. 16b shows a slot 1612e exposed to a vacuum environment as a result of linear guide 1624 translating in a negative direction along an x-axis 1644. Since the volume of the pocket created within slot 1612e is relatively small, the gas released into vacuum environment from slot 1612e is relatively small. In addition to being of a relatively small volume, since the pressure of the released gas is at approximately the pressure of gas associated with high vacuum groove 1620, the effect of the gas on the surrounding vacuum environment may not significantly affect the vacuum.

When linear guide 1624 passes over slots 1612, as each slot 1612 is exposed to a surrounding vacuum environment, a series of pressure bursts may occur. Bursts of pressure may also occur repeatedly when linear guide 1624 undergoes substantially reciprocal motion. In general, pressure changes which result from gas being released from slots 1612 as linear guide 1624 passes over slots 1624 are acceptable for many vacuum applications. However, for applications in which significant leakage may occur even with the use of slots 1612, when recess depth R, for example, is in excess of the order of tens of microns, recess depth R may effectively be reduced by implementing a configuration for plate 1628 that is similar to that of plate 1412a of FIG. 14.

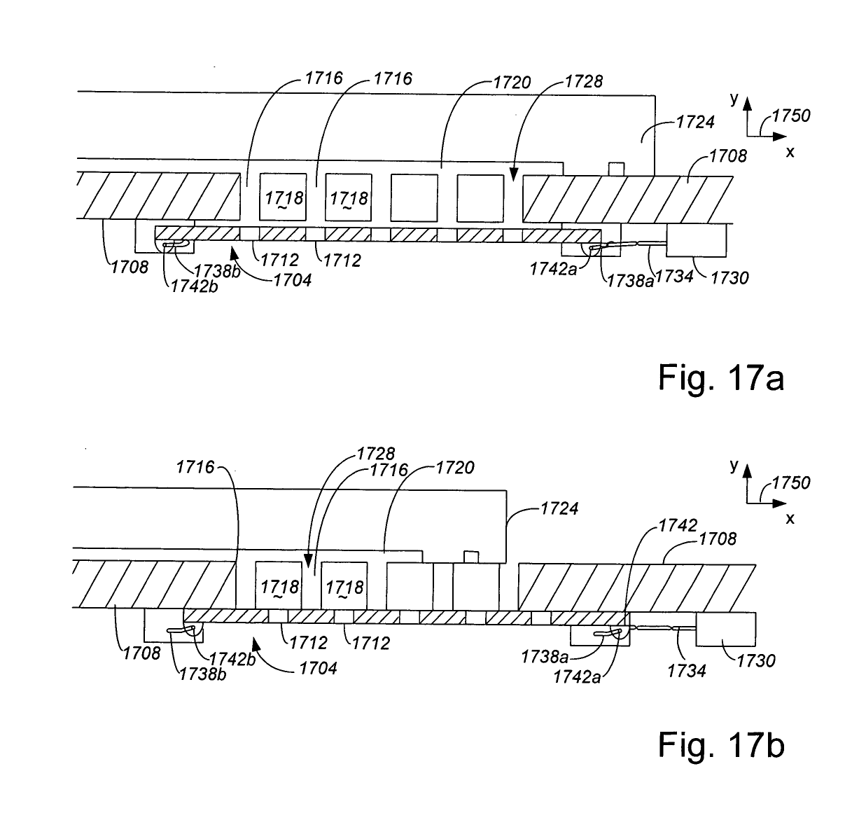

Slots within an exhaust port may be implemented in a variety of different manners. For example, in lieu of implementing slots with a plate which may be moved away from a first surface of a guide beam, slots may be implemented with respect to a plate which slides with respect to the first surface of the guide beam to effectively open and close slots. With reference to FIGS. 17a and 17b, an exhaust port plate which is arranged to slide to open slots of an exhaust port will be described in accordance with an embodiment of the present invention. A plate 1704 is arranged below a first surface of a guide beam 1708. Plate 1704, which effectively functions as a valve, includes openings 1712 which are arranged to coincide with slots 1716 when exhaust port 1728 is in an open position, as shown in FIG. 17a. When exhaust port 1728 is in an open position, overall open slots created by openings 1712 and slots 1716 enable fluid or gas to flow through the slots between a groove 1720 in a linear guide 1724 and an internal chamber of the guide beam. Alternatively, when exhaust port 1728 is in a closed position, as shown in FIG. 17b, openings 1712 are arranged not to coincide with slots 1716 such that slots 1716 are substantially sealed. Seals (not shown) may be arranged at corners of first surface 1708 and corners of slot dividers 1718 which may come into contact with plate 1704, to completely seal an internal chamber of the guide beam from an internal area 1720 of the linear guide 1724.

Plate 1704 may be moved or actuated using substantially any suitable mechanism. In the described embodiment, in order for plate 1704 to be shifted or translated along an x-axis 1750, an actuator 1730 is coupled to a flexible shaft 1734 which holds a pin 1742a substantially within a guide slot 1738a. Pin 1742a is arranged to be coupled to plate 1704 such that when pin 1742a moves, plate 1704 moves. Actuator 1730 is arranged to push or pull shaft 1732 such that pin 1742a is moved within guide slot 1738a. As pin 1742a moves in guide slot 1738a, plate 1704 may be moved such that openings 1712 may be moved to coincide with pockets 1716 to open exhaust port 1728, and to coincide with slot dividers 1718 to close exhaust port 1728. Guide slot 1738a, in one embodiment, is shaped so that plate 1704 and its seals (not shown) do not rub against exhaust port 1728, except when exhaust port 1728 is almost in a closed position, when the shape of slot 1738a forces the seals into contact with the slot dividers 1718, thereby assuring a secure seal. In one embodiment, a pin 1742b is arranged to move within a guide slot 1738b as pin 1742a moves in guide slot 1738a.

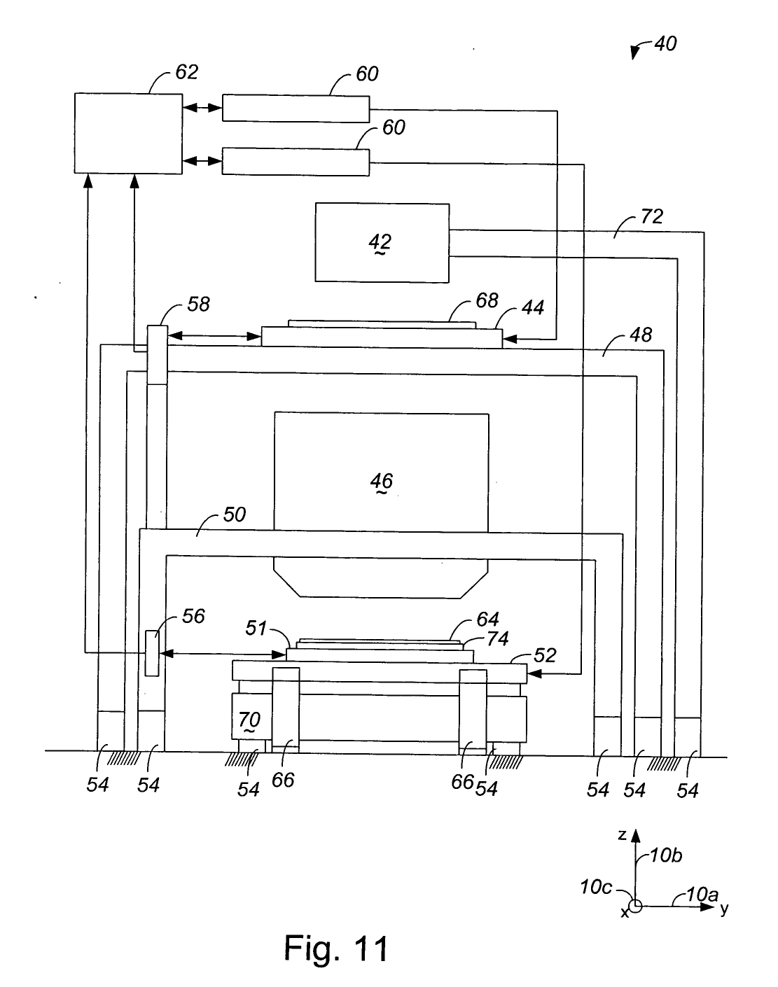

An air bearing arrangement which includes a beam with a plurality of ports, e.g., exhaust ports, may be implemented for use with substantially any suitable photolithography apparatus. With reference to FIG. 11, a photolithography apparatus which may include a vacuum compatible air bearing with a stroke which is substantially independent of the length of the air bearing will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator, e.g., an EI-core actuator with a top coil and a bottom coil which are substantially independently controlled. The planar motor which drives wafer positioning stage 52 may use an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, and is arranged to project a radiant energy, e.g., light, through a mask pattern on a reticle 68 that is supported by and scanned using a reticle stage which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties. Isolators 54 may also be length-adjustable bellows and, further, may be part of an overall active vibration isolation system (AVIS), as will be discussed below .

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes wafer 64 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. It should be appreciated that an exposure device which employs VUV radiation is an example of an exposure device which uses extreme ultra-violet radiation. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly.

A photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

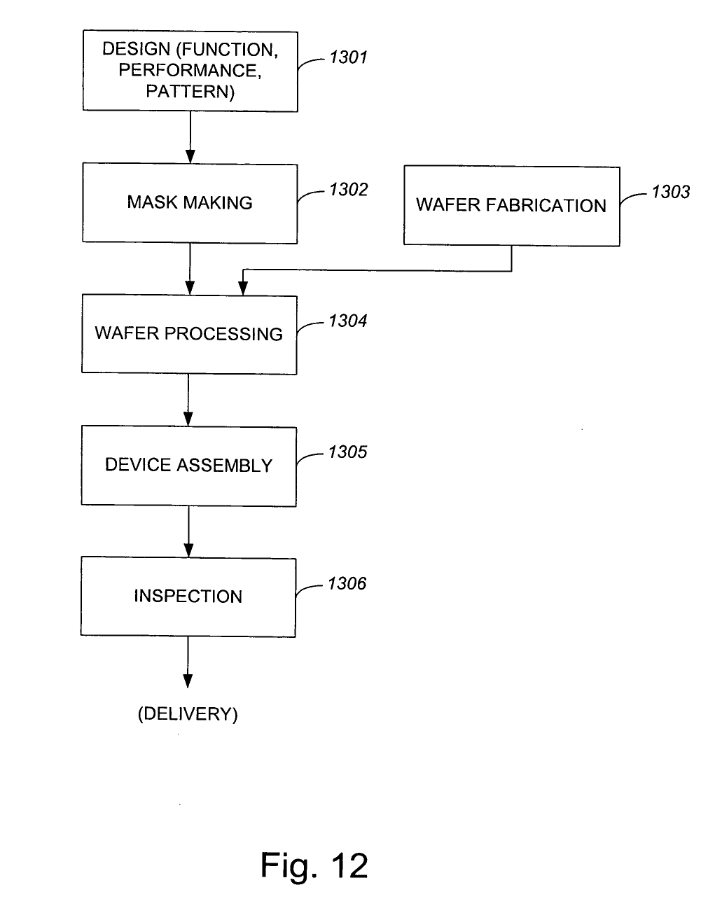

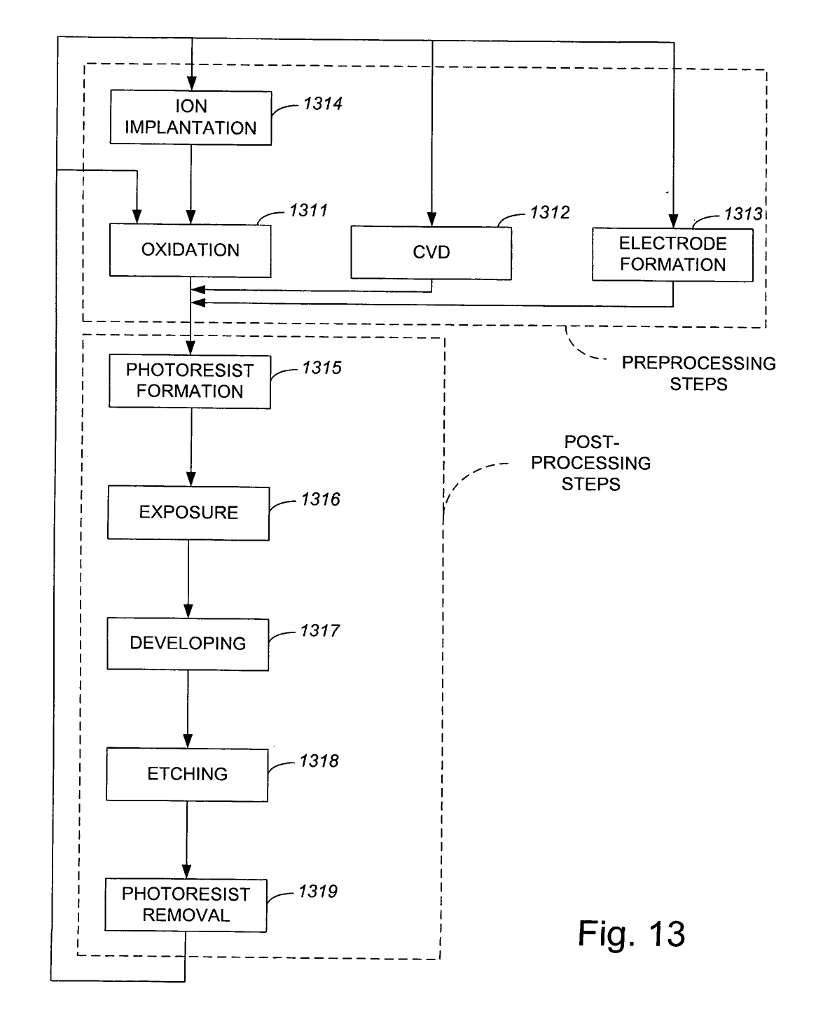

Further, semiconductor devices may be fabricated using systems described above, as will be discussed with reference to FIG. 12. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 13. In step 1305, the semiconductor device is assembled. The assembly of the semiconductor device generally includes, but is not limited to, wafer dicing processes, bonding processes, and packaging processes. Finally, the completed device is inspected in step 1306.

FIG. 13 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while mechanisms arranged to enable exhaust ports to be opened and closed have generally been described as valve mechanisms, it should be appreciated that mechanisms arranged to enable exhaust ports to be opened and closed may be substantially any type of mechanism.

A guide bearing system has generally been described as being suitable for implementation as a part of a wafer scanning stage. The use of a guide bearing system of the present invention, however, may also be implemented for use as a part of substantially any suitable reticle scanning system. As previously mentioned, while a guide bearing system which includes a guide beam with a plurality of exhaust ports which are in communication with a common chamber of the guide beam is suitable for use as a part of a scanning stage apparatus of an electron beam projection system, such a guide bearing system may generally be used as a part of a variety of different systems. The different systems include, but are not limited to, systems which use extreme ultra-violet technology, electron beam inspection machines, wafer repair machines, and reticle repair machines.

The configuration of a guide bearing system which includes an air bearing linear guide and a guide beam with multiple sealable exhaust ports may generally be widely varied. For example, chambers or ducts within a guide beam may be arranged such that exhaust ports for each of the chambers are located on a common side of the guide beam. More generally, the location of exhaust ports along a surface or surfaces of a guide beam, as well as the configuration of the guide beam, may vary.

The number of exhaust ports on a guide beam, as well as the dimensions associated with the exhaust ports, may vary depending on factors which include, but are not limited to, the desired stroke length of a linear guide. For instance, if a longer stroke length is desired, additional exhaust ports may be implemented on or within a guide beam.

In general, the number of sets of exhaust ports on a guide beam may vary, although the use of two sets, namely a low vacuum set and a high vacuum set, has been described. By way of example, for an embodiment in which only one type of vacuum exhaust port is needed, a single set of vacuum exhaust ports which are exhausted to the same internal chamber of a guide beam may be used. Alternatively, in the event that there are more than two types of vacuums to be exhausted, more than two sets of exhaust ports may be implemented. In one embodiment, if it is desired to have a guide bearing system with a high vacuum, a low vacuum, and an intermediate vacuum, then three different sets of exhaust ports may be implemented on a guide beam without departing from the spirit or the scope of the present invention.

A seal such as an o-ring, i.e., an o-ring that is seated either in a groove on a cover plate or in a groove on a surface of a guide beam, has been described as providing adequate sealing capabilities when the o-ring is in contact with a cover or a plate. Other types of seals which may be suitable for use to seal exhaust ports includes gaskets and substantially any seals which are formed from a relatively pliant material. Therefore, the present examples are to be considered as illustrative and not restrictive, and the invention is not to be limited to the details given herein, but may be modified within the scope of the appended claims.

What is claimed is:

1. A guide bearing system, the guide bearing system comprising:
a linear guide, the linear guide having an inner surface which includes an air pad; and
a first guide beam, the linear guide being arranged to substantially wrap around the first guide beam and to slide with respect to the guide beam, the guide beam including a first chamber, the first chamber being in fluid communication with the linear guide through at least one of a first plurality of ports in the guide beam which enable access to the first chamber.

2. The guide bearing system of claim 1 wherein the linear guide is arranged to substantially overlap a first port of the first plurality of ports in the guide beam, wherein when the linear guide substantially overlaps the first port, the first chamber is in fluid communication with the linear guide through the first port.

3. The guide bearing system of claim 2 wherein when the linear guide substantially overlaps the first port, the first port is open and at least a second port of the first plurality of ports in the guide beam is substantially closed.

4. The guide bearing system of claim 3 wherein when the second port is substantially closed, the first chamber is not in fluid communication with the linear guide through the second port.

5. The guide bearing system of claim 3 wherein when the second port is substantially closed, the linear guide does not overlap the second port.

6. The guide bearing system of claim 3 wherein when the second port is substantially closed, the linear guide overlap a first portion of the second port while a second portion of the second port is not overlapped by the linear guide.

7. The guide bearing system of claim 2 wherein the first port includes a valve arrangement, the valve arrangement being arranged to substantially seal and unseal the first port.

8. The guide bearing system of claim 7 wherein when the linear guide substantially overlaps the first port, the first port is substantially unsealed such that the first chamber is in fluid communication with the linear guide through the first port.

9. The guide bearing system of claim 7 wherein the valve arrangement includes a seal.

10. The guide bearing system of claim 7 wherein the valve arrangement is an active valve arrangement.

11. The guide bearing system of claim 7 wherein the valve arrangement is a passive valve arrangement.

12. The guide bearing system of claim 1 wherein the first guide beam further includes a second chamber, the second chamber being in fluid communication with the linear guide through at least one of a second plurality of ports in the guide beam which enable access to the second chamber.

13. An exposure apparatus comprising the guide bearing system of claim 1.

14. A device manufactured with the exposure apparatus of claim 13.

15. A wafer on which an image has been formed by the exposure apparatus of claim 13.

16. The exposure apparatus of claim 13 wherein the exposure apparatus includes one of an electron beam lithography system and an extreme ultra-violet lithography system.

17. A guide bearing system, the guide bearing system comprising:
a linear guide, the linear guide including an inner surface which includes an air pad; and
a first guide beam, the linear guide being arranged to substantially wrap around the first guide beam and to slide with respect to the guide beam, the guide beam including a first chamber with a first port, wherein the first port includes a first sealing arrangement that is arranged to control access to the first chamber, the first chamber being in fluid communication with the linear guide through the first port when the first sealing arrangement is arranged to enable access to the first chamber.

18. The guide bearing system of claim 17 wherein the first sealing arrangement is arranged to enable access to the first chamber through the first port when the linear guide substantially overlaps the first port.

19. The guide bearing system of claim 17 wherein the first sealing arrangement is arranged to seal the first port to substantially prevent access to the first chamber through the first port when the linear guide overlaps a first portion of the first port and not a second portion of the first port.

20. The guide bearing system of claim 17 wherein the first sealing arrangement is arranged to seal the first port to substantially prevent access to the first chamber through the first port when the linear guide does not overlap the first port.

21. The guide bearing system of claim 17 wherein the first chamber further includes a second port, the second port including a second sealing arrangement that is arranged to control access to the first chamber through the second port, wherein the first chamber is in fluid communication with the linear guide through the second port when the second sealing arrangement is arranged to enable access to the first chamber.

22. The guide bearing system of claim 17 wherein the first sealing arrangement includes a plate and a seal, wherein the plate is arranged to hold the seal against a surface of the first guide beam to substantially prevent access to the first chamber through the first port.

23. The guide bearing system of claim 22 wherein the first sealing arrangement further includes an actuator, the actuator being arranged to provide a force on the plate to hold the seal against the surface.

24. The guide bearing system of claim 17 wherein the first guide beam further includes a second chamber with a second port, the second port including a second sealing arrangement that is arranged to control access to the second chamber, the second chamber being in fluid communication with the linear guide through the second port when the second sealing arrangement is arranged to enable access to the second chamber.

25. An exposure apparatus comprising the guide bearing system of claim 17.

26. A device manufactured with the exposure apparatus of claim 25.

27. A wafer on which an image has been formed by the exposure apparatus of claim 25.

28. The exposure apparatus of claim 25 wherein the exposure apparatus includes one of an electron beam lithography system and an extreme ultra-violet lithography system.

29. A method for scanning a stage, the stage being coupled to an air bearing linear guide, the air bearing linear guide being arranged to slide over a guide beam, wherein the guide beam includes an internal chamber with at least a first exhaust port and a second exhaust port on a first side, the method comprising:
sliding the air bearing linear guide to overlap the first exhaust port;
maintaining the first exhaust port in a substantially open configuration when the air bearing linear guide overlaps the first exhaust port, wherein the open configuration is arranged to enable fluid communication between the air bearing linear guide and the internal chamber; and
maintaining the second exhaust port in a substantially closed configuration when the air bearing linear guide does not overlap the second exhaust port, wherein the closed configuration is arranged to substantially minimize fluid communication with the internal chamber through the second exhaust port.

30. The method of claim 29 wherein when the air bearing linear guide overlaps the first exhaust port, substantially all of the first exhaust port is positioned within an outline defined by the air bearing linear guide.

31. The method of claim 29 further including:
maintaining the second exhaust port in the substantially closed configuration when a first portion of the second exhaust port is overlapped by an outline defined by the air bearing linear guide and a second portion of the second exhaust port is not overlapped by the outline.

32. The method of claim 29 further including:
sliding the air bearing linear guide to overlap the second exhaust port in addition to the first exhaust port such that the first exhaust port is within an outline defined by the air bearing linear guide and the second exhaust port is within the outline.

33. The method of claim 32 further including
transitioning the first exhaust port from the substantially open configuration into a substantially closed configuration to substantially minimize the fluid communication with the internal chamber through the first exhaust port when the air bearing linear guide overlaps the first exhaust port and the second exhaust port; and
transitioning the second exhaust port from the substantially closed configuration into a substantially open configuration to enable the fluid communication with the internal chamber through the second exhaust port when the air bearing linear guide overlaps the first exhaust port and the second exhaust port.

34. The method of claim 33 further including:
sliding the air bearing linear guide such that the air bearing linear guide overlap the second exhaust port and not the first exhaust port;
maintaining the first exhaust port in the substantially closed configuration when the air bearing linear guide overlaps the second exhaust port and does not overlap the first exhaust port; and
maintaining the second exhaust port in the substantially open configuration when the air bearing linear guide overlaps the second exhaust port and not the first exhaust port.

35. The method of claim 29 wherein the first exhaust port includes a valve arrangement, and maintaining the first exhaust port in the substantially open configuration includes maintaining the valve arrangement in an open position.

36. The method of claim 29 wherein the second exhaust port includes a valve arrangement, and maintaining the second exhaust port in the substantially closed configuration includes maintaining the valve arrangement in a closed position.

37. A method for operating an exposure apparatus comprising the method of claim 29.

38. A method for making an object including at least a photolithography process wherein the photolithography process utilizes the method of operating an exposure apparatus of claim 37.

39. A method for making a wafer utilizing the method of operating an exposure apparatus of claim 37.
